(19) United States
(12) Patent Application Publication
(10) Pub. No.: US 2006/0035533 A1
(43) Pub. Date: Feb. 16, 2006

(54) Wiring harness for vehicle

(75) Inventors: Yoshiaki Yamano, Mie (JP); Toshio Shimizu, Mie (JP); Koutarou Maeda, Mie (JP); Takeharu Ito, Mie (JP); Akira Hibasami, Mie (JP)

Correspondence Address: OLIFF & BERRIDGE, PLC, P.O. BOX 19928, ALEXANDRIA, VA, 22320, US

(73) Assignees: AUTONETWORKS TECHNOLOGIES, LTD., Yokkaichi-shi (JP); SUMITOMO WIRING SYSTEMS, LTD., Yokkaichi-shi (JP); SUMITOMO ELECTRIC INDUSTRIES, LTD., Osaka-Shi (JP)

(21) Appl. No.: 11/193,357

(22) Filed: Aug. 1, 2005

(30) Foreign Application Priority Data
Jul. 30, 2004 (JP) P2004-224077
Jul. 4, 2005 (JP) P2005-194854

(51) Int. Cl. H01R 9/22

(52) U.S. Cl. 439/712

(57) ABSTRACT

A wiring harness for a vehicle includes a first wire, a second wire and a third wire. The first wire has a conductor formed by aggregating at least one high-tensile wire material and a plurality of conductive element wires. The second wire has a compressed conductor formed by compressing and aggregating a plurality of element wires. The wiring harness is formed by aggregating a cable including the first wire, the second wire. A cross sectional area of the conductor of the first wire is smaller than a cross sectional area of the compressed conductor of the second wire.

### BACKGROUND OF THE INVENTION

1. Field of the Invention

The present invention relates to a wiring harness for a vehicle, and more particularly, to a wiring harness having high tensile strength, high flexibility, a small diameter, and light weight by using extra-fine wires for cables thereof.

2. Description of the Related Art

Wiring harnesses, which are formed by aggregating a plurality of cable groups connected to electrical components, are provided in a vehicle. Recently, with the development of the function of the vehicle, the number of cables forming the wiring harness increases. Particularly, as the number of cables used in a small current circuit for a signal rapidly increases, there has been a problem in that the size of the wiring harness becomes larger. Even when each of the signal cables includes a conductor having a cross-sectional area of 0.3 mm² or less, it is possible to secure a sufficient amount of current flowing through each of the cables. However, if a conductor of each of the cables has a small cross-sectional area, tensile strength of the cables is lowered, whereby the cable may be cut during the assembly of the wiring harness or a vehicle.

Consequently, there has been an attempt to reduce the diameter and weight of the cable by compressing the conductor of the cable and by reducing the thickness of an insulating layer covering the conductor.

However, it is difficult to sufficiently reduce the diameter and weight of the wiring harness by compressing the conductor of the cable.

In addition, when the thickness of the insulating layer is reduced, the weight of the cable can be reduced. However, the insulating layer is necessary to be formed with a resin having higher abrasion resistance in order to maintain the abrasion resistance of the insulating layer. In this case, since the insulating layer is hardened, the cable is hardened. Therefore, it is difficult to bend the cable.

When the wiring harness is provided in a vehicle, the wiring harness should be bent in a predetermined shape. Accordingly, if the wiring harness includes a plurality of cables each having hard insulating layers, there has been problems in that much time and effort are required for bending the wiring harness, whereby working efficiency deteriorates.

Inventors provide a wiring harness disclosed in JP-A-2002-231058 as a countermeasure for improving flexibility of the wiring harness. As shown in FIG. 10, circular arc crest parts 2 and trough parts 3 are continuously formed on the outer circumferential surface of an insulating layer 1 of each of cables w in the circumferential direction thereof so that contact pressure among several cables w is reduced by increasing contact portions among the cables w to allow the wiring harness to be flexed when the cables w are aggregated to form the wiring harness.

However, when the wiring harness H/W disclosed in JP-A-2002-231058 is used, each of the trough parts 3 of the insulating layer 1 needs to have a required thickness, and each of the crest parts 2 is thicker than each of the trough parts 3 to secure the strength of each cable w. For this reason, an outer diameter of each of the cables increases, and the size of the wiring harness becomes large. Therefore, the problem of an increase in the size of the wiring harness is not completely solved.

### SUMMARY OF THE INVENTION

It is an object of the invention to provide a wiring harness for a vehicle which is easily bent during wiring in a vehicle by reducing the diameter and weight of the wiring harness and by allowing the wiring harness to be flexible, thereby improving the efficiency of a wiring work.

According to one aspect of the invention, there is provided a wiring harness for a vehicle, including: a first wire having a conductor formed by aggregating at least one high-tensile wire material and a plurality of conductive element wires; a second wire having a compressed conductor formed by compressing and aggregating a plurality of element wires; and a third wire having a conductor formed by aggregating a plurality of element wires. The wiring harness is formed by aggregating a cable including the first wire, the second wire, and the third wire. A cross sectional area of the conductor of the first wire is smaller than a cross sectional area of the compressed conductor of the second wire. The cross sectional area of the compressed conductor of the second wire is smaller than a cross sectional area of the conductor of the third wire.

In addition, alternatively, a wiring harness for a vehicle may be formed by aggregating a plurality of cables which includes extra-fine wires(first wire) and fine wires(second wire), excluding the thick wires(third wire). In this case, there is provided a wiring harness for a vehicle, including: a first wire having a conductor formed by aggregating at least one high-tensile wire material and a plurality of conductive element wires; and a second wire having a compressed conductor formed by compressing and aggregating a plurality of element wires. The wiring harness is formed by aggregating a cable including the first wire, the second wire. A cross sectional area of the conductor of the first wire is smaller than a cross sectional area of the compressed conductor of the second wire.

In the above-mentioned structure, a cable whose conductor has a cross-sectional area of 0.05 to 0.3 mm² is used as an extra-fine wire, a cable whose conductor has a cross-sectional area of larger than 0.3 mm² and smaller than 1.5 mm² is used as a fine wire, and a cable whose conductor has a cross-sectional area of larger than 1.5 mm² is used as a thick wire.

The conductor of each extra-fine wire, the fine wires, and the thick wires forming the wiring harness is covered with an insulating layer made of an insulating resin, and the thickness of the insulating layer is set to be substantially equal to that in the related art so as to insulate and protect the conductor.

According to another aspect of the invention, the high-tensile wire material of the first wire is configured by a conductive core wire. Each conductive element wire of the first wire has a smaller diameter than the high-tensile wire material of the first wire. The conductor of the third wire is configured by a plurality of element wires which are twisted.

In the cables of the related art, a conductor (core wire) of each extra-fine wire and fine wires has a twisted-structure formed by twisting a plurality of element wires which are made of copper or a copper alloy and have the same diameter, similar to thick wires.

According to the above-aspects of the invention, the conductor of each extra-fine wire has a twisted-structure which is formed by aggregating at least one high-tensile wire material and a plurality of conductive element wires. Accordingly, even when the cable whose conductor has a cross-sectional area of 0.05 to 0.3 mm² is used as an extra-fine wire, it is possible to improve tensile strength of the extra-fine wires due to the high-tensile wire material. Therefore, it is possible to secure the reliability of mechanical strength of the wiring harness.

In this way, since the conductor of each of the extra-fine wires has high tensile strength, it is possible to secure the flexibility of the insulating layer by forming the insulating layer with a resin as in the related art. Accordingly, it is possible to achieve flexible cables having a small diameter. Furthermore, since the diameter of the overall wiring harness is reduced by reducing the diameter of each of the extra-fine wires for a signal which account for a large percentage of the cable groups forming the wiring harness, it is possible to reduce a wiring space for the wiring harness in the vehicle, and to improve the efficiency of a wiring work.

Specifically, 20% or more of cables forming one wiring harness are configured by the extra-fine wires.

It is possible to reduce the diameter and weight of the wiring harness by replacing 20% of cables forming the wiring harness with the extra-fine wires whose conductors have a cross-sectional area of 0.05 to 0.3 mm². Moreover, since the wiring harness is formed by aggregating a plurality of extra-fine wires which has high flexibility, it is possible to improve the flexibility of the wiring harness.

Consequentially, when the wiring harness is provided in a vehicle, the wiring harness can be easily bent in a predetermined shape, whereby it is possible to improve the working efficiency of the wiring harness.

Since 20 to 50% of cable groups forming the wiring harness include signal wires capable of being replaced with the extra-fine wires on the average, 20% or more of cables forming the wiring harness are configured by the extra-fine wires.

Generally, the cables forming the wiring harness are broadly classified into power wires, earth wires, and signal wires. It is preferable that the amount of current flowing through each of the signal wires be small. However, a cable whose conductor has a cross-sectional area of 0.35 mm² (which is larger than a required cross-sectional area) has been used as a signal wire to secure the tensile strength of the cable.

Even when each of the extra-fine wires whose conductor has a cross-sectional area of 0.05 to 0.3 mm² is used, the tensile strength of the cables can be secured. Therefore, the extra-fine wires capable of securing the required amount of current are replaced to be used as signal wires.

According to the above-aspect of the invention, the wiring harness can be properly applied to an instrument panel harness which is formed by aggregating the largest cable groups and has many signal wires, and the extra-fine wires preferably account for 20 to 50% of the cables of the instrument panel harness.

The conductor of each extra-fine wire may be configured by one high-tensile wire material, serving as a thick central element wire, and seven to nine conductive element wires which are closely arranged around the central element so as to surround the outer circumferential surface thereof.

In addition, the conductor of each of the extra-fine wires may be formed by closely arranging the seven to nine conductive element wires on the circumferential surface of several high-tensile wire materials. In this case, the number of high-tensile wire materials may be preferably two to four, and the diameter of each of the high-tensile wire materials may be smaller than that of each of the conductive element wires.

Specifically, the high-tensile wire material configured by the central element wires is preferably made of stainless steel, and copper or a copper alloy may be used for the conductive element wires which are arranged on the circumferential surface of the central element wires.

The element wires made of high-strength stainless steel are used as a central element wire in the conductor of each of the extra-fine wires. Therefore, even when each of the extra-fine wires is used as a cable, it is possible to secure the tensile strength of each of the cables.

The cross-sectional area of the central element wire is preferably set within the range of 13 to 35% of the cross-sectional area of the conductor.

Though various types of stainless steel can be used as materials for the high-tensile wire materials, particularly, SUS304, SUS316, or the like which has high tensile strength is preferably used as a material for the high-tensile wire materials.

Furthermore, copper or a copper alloy generally used for a cable can be used as a material for the conductive element wires which are arranged on the circumferential surface of the high-tensile wire materials. However, it is preferable to use pure copper, Cu—Ag alloy, Cu—Ni—Si alloy or the like as a material forming the conductive element wires in regard to conductivity, tensile strength, elongation, and the like.

A material forming the insulating layer covering the conductor is not particularly limited, and the thickness of the insulating layer is preferably set within the range of 0.1 to 0.3 mm, and more preferably, to 0.2 mm.

Preferably, the insulating layer covering each of the fine wires which has a compressed conductor is made of high-strength olefin-based resin, and the thickness of the insulating layer is preferably equal to the thickness (about 0.2 mm) of the insulating layer of each of the extra-fine wires.

According to the above-aspects of the invention, an extra-fine wire in which a conductor is configured by at least one high-tensile wire material and a plurality of conductive element wires and has a cross-sectional area of 0.05 to 0.3 mm² is used as a signal wire or a cable for a small current circuit of the cable groups forming the wiring harness. In addition, a fine wire configured by a compressed conductor whose cross-sectional area is set within the range of 0.3 to 1.5 mm² is used as a cable for a small current circuit. Therefore, it is possible to reduce the diameter of the wiring harness. Since the conductor of each of extra-fine wires has high tensile strength, it is possible to achieve an extra-fine wire having high tensile strength, a small diameter, and high flexibility.

Consequentially, when the wiring harness is provided in a vehicle, the wiring harness can be easily bent in a predetermined shape, whereby it is possible to improve the working efficiency of the wiring harness.

### BRIEF DESCRIPTION OF THE DRAWINGS

These and other objects and advantages of this invention will become more fully apparent from the following detailed description taken with the accompanying drawings in which:

FIG. 1 is a view showing a wiring harness configured by an instrument panel harness according to a first embodiment of the invention;

FIG. 2 is a conceptual perspective view of the wiring harness shown in FIG. 1;

FIG. 3A is a cross-sectional view showing a state in which circumferential element wires are arranged on the outer circumferential surface of a central element wire in an extra-fine wire;

FIG. 3B is a cross-sectional view showing a compressed state;

FIG. 3C is a cross-sectional view showing a state in which a conductor is covered with an insulating layer;

FIG. 4 is an enlarged cross-sectional view showing the wiring harness of FIG. 1;

FIG. 5 is a cross-sectional view showing the extra-fine wire according to a modification of the first embodiment;

FIG. 6 is a perspective view showing a wiring harness according to a second embodiment;

FIG. 7 is a view showing a method of measuring rigidity of the wiring harness;

FIG. 8 is a line graph showing the result of measuring the rigidity of the wiring harness;

FIG. 9 is a line graph showing a relation between the number of cables and rigidity; and

FIGS. 10A and 10B are perspective views showing a conventional wiring harness.

### DESCRIPTION OF THE PREFERRED EMBODIMENTS

Hereinafter, preferred embodiments of the invention will be described with reference to the accompanying drawings.

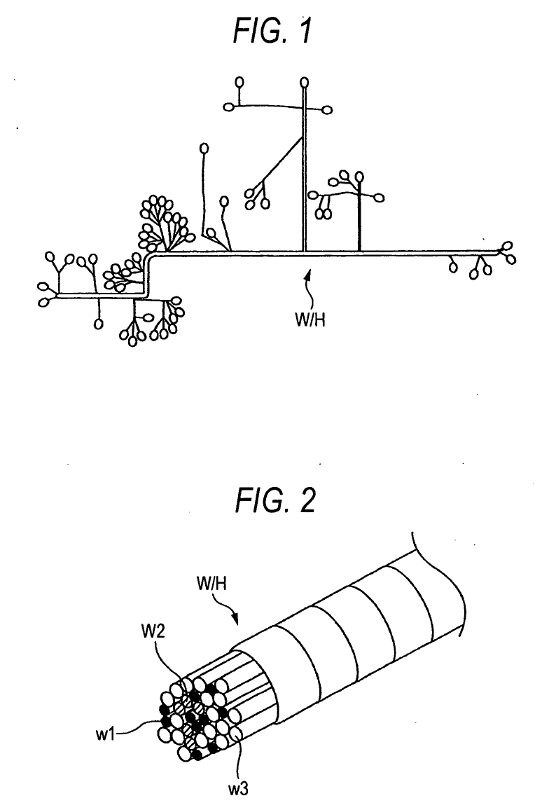

FIGS. 1 to 4 are views showing a first embodiment according to the invention. FIG. 1 shows a wiring harness W/H that is configured by an instrument panel harness provided in an instrument panel of a car 20 to 50% (30% in the present embodiment) of cables forming the wiring harness H/W are configured by extra-fine wires w1 (first wire) whose cross-sections are indicated by black in FIG. 2. The wiring harness H/W is formed by aggregating cable groups each including the extra-fine wires w1, fine wires w2 (second wire)(whose cross-sections are indicated by hatching), and thick wires w3(third wire).

The extra-fine wire w1 includes a conductor having a cross-sectional area of 0.35 mm².

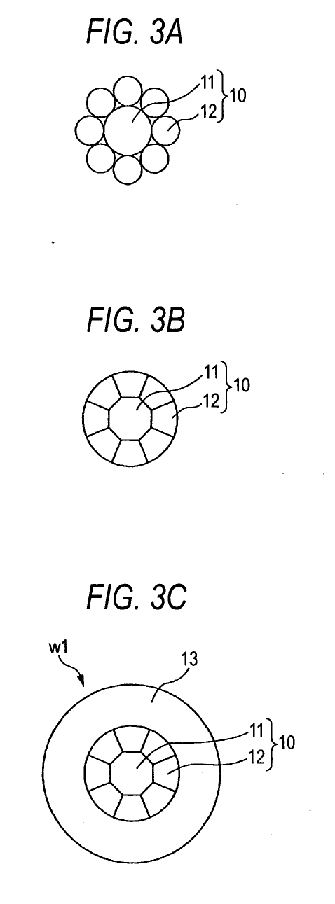

As shown in FIG. 3, each of the extra-fine wires w1 includes a central element wire 11 that is a high-tensile wire material made of stainless steel, and eight circumferential element wires 12 that are closely arranged on the outer circumferential surface of the central element wire 11 and are made of copper. The eight circumferential element wires 12 are twisted around the central element wire 11 to form a twisted-wire structure, and the eight circumferential element wires 12 are pressed against the central element wire 11 to form a conductor 10.

The cross-sectional area of the conductor 10 is set within the range of 0.05 to 0.3 mm² (0.13 mm² in the present embodiment), and the cross-sectional area of the central element wire 11 made of stainless steel is set within the range of 13 to 35% of the cross-sectional area of the conductor 10. In the present embodiment, the cross-sectional area of the central element wire 11 is set to 24.4% of the cross-sectional area of the conductor 10.

An insulating layer 13 covering the conductor 10 is made of a high-strength resin (olefin resin) which is the same material as that used in each of the fine wires w2, and the thickness thereof is set to 0.2 mm.

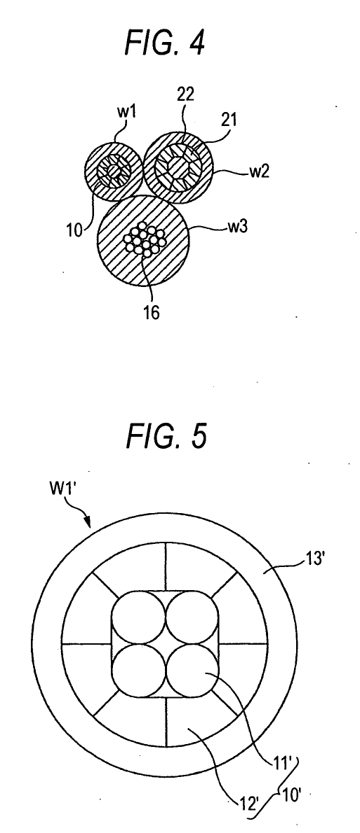

As shown in FIG. 4, in each of the fine wires w2, a compressed conductor 20 is formed by closely arranging and compressing a plurality of element wires 21 which have the same diameter and are made of copper. In this case, the cross-sectional area of the compressed conductor 20 is set within the range of 0.3 to 1.5 mm². An insulating layer 22 covering the compressed conductor 20 is made of a high-hardness resin (olefin-based resin). In this case, the compressed conductor 20 is compressed to reduce the diameter thereof, and the thickness of the insulating layer 22 is set to 0.2 mm that is the same thickness as that of the insulating layer 13 of each extra-fine wire w1.

In each of the thick wires w3, a conductor 16 has a cross-sectional area of larger than 1.5 mm². The conductor 16 of each of the thick wires w3 is configured by a twisted wire including a plurality of element wires, and is a general-purpose cable in which the twisted wire is uncompressed. An insulating layer 33 thereof is made of a resin (polyvinyl chloride), similar to the related art, and has a thickness (0.4 mm).

In the wiring harness in which the extra-fine wires w1, the fine wires w2, and the thick wire 3 are aggregated, since 20 to 50% of cable groups forming the wiring harness W/H are the extra-fine wires w1, it is possible to considerably reduce the diameter of the wiring harness W/H. In addition, since the central element wire 11 made of stainless steel is used as the conductor 10 of each of the extra-fine wires w1, it is possible to secure tensile strength of a cable even when the extra-fine wires w1 are used.

Furthermore, since the cross-sectional area of the conductor of each fine wire w2 is reduced by compressing the conductor and the thickness of the insulating layer 22 is reduced, it is possible to reduce the outer diameter of the wiring harness W/H by combining the extra-fine wires w1 with the fine wires w2.

More specifically, the conductor of each of the extra-fine wires w1 has a diameter reduced by 23% compared to a conductor of a cable which has been used in the related art and has a cross-sectional area of 0.35 mm². The weight of each extra-fine wire w1 is reduced by 51% compared to a cable which has the same length and a cross-sectional area of 0.35 mm². Accordingly, it is possible to reduce the outer diameter and weight of the wiring harness W/H, and to improve wiring workability in the vehicle by replacing 20 to 50% of cable groups forming the wiring harness W/H with the extra-fine wires w1.

The extra-fine wire is used for a signal circuit, the fine wire is used for a small current circuit in which the amount of required current is relatively small, and the thick wire is used for a medium/large current circuit in which the amount of required current is relatively large. Therefore, it is possible to form cable groups forming the wiring harness with cables corresponding to the amount of required current.

FIG. 5 is a cross-sectional view showing a modification of the first embodiment.

In the present modification, the number of central element wires, which constitute a conductor of each extra-fine wire and are made of high-tensile wire materials (stainless steel), is different from that in the first embodiment.

That is, as shown in FIG. 5, each extra-fine wire w1′ of the present modification includes four central element wires 11′ that are high-tensile wire materials made of stainless steel, and eight circumferential element wires 12′ that are closely arranged on the outer circumferential surface of the central element wires 11′ and are made of copper. The four central element wires 11′ are twisted to form a twisted wire, and the circumferential element wires 12′ are twisted around the central element wires 11′ to form a twisted-wire structure. Then, the circumferential element wires 12′ are pressed against the central element wires 11′ to form a conductor 10′.

In addition, in the present modification, the central element wire 11′ has a diameter of 0.140 mm, and the circumferential element wire 12′ has a diameter of 0.190 mm, so that the diameter of the central element wire 11′ is smaller than that of the circumferential element wire 12′.

The cross-sectional area of the conductor 10′ is set to 0.22 mm², and the cross-sectional area formed by the four central element wires 11′ is set to 20% of the cross-sectional area of the conductor 10′.

An insulating layer 13′ covering the conductor 10′, similar to the first embodiment, is made of a high-strength resin (olefin resin) having a thickness of 0.2 mm.

According to the above-mentioned structure, similar to the first embodiment, it is possible to reduce the diameter of the cable while maintaining tensile strength of the extra-fine wires. Furthermore, since the four central element wires 11′ are twisted to form a twisted wire, it is possible to improve flexibility of the extra-fine wire.

Moreover, since other structures and effects of the present modification are the same as those of the first embodiment, the same parts as those in the first embodiment are indicated by the same reference numerals, and a description thereof is omitted.

In addition, the extra-fine wires w1′ can be used in a wiring harness according to a second embodiment, which will be described below.

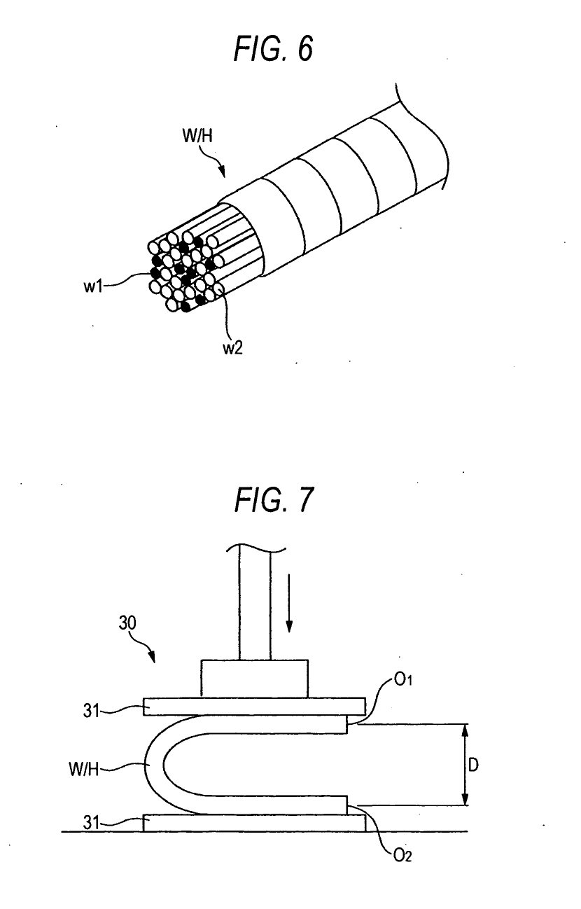

FIG. 6 is a perspective view showing a second embodiment of the invention 20 to 50% (30% in the present embodiment) of cables forming a wiring harness H/W are configured by extra-fine wires w1, and the other cables are configured by fine wires w2 each including a compressed conductor 20 and a thin insulating layer 22.

Since the extra-fine wires w1 and the fine wires w2 have the same structures as those in the first embodiment, a description thereof is omitted.

The percentage of the fine wires w2 each including an insulating layer 22 made of a high-strength resin is large in the wiring harness H/W, and the fine wires w2 are relatively rigid. However, since about 30% of cables forming the wiring harness H/W are configured by the extra-fine wires w1, the flexibility of the wiring harness H/W are not deteriorated as a whole. Accordingly, the wiring harness H/W that is formed by aggregating the extra-fine wires w1 and the fine wires w2 can generally secure substantially the same tensile strength and flexibility as the wiring harness H/W.

Next, rigidity of the wiring harness W/H1 is compared with rigidity of a wiring harness W/H2 and a wiring harness W/H3. In this case, the wiring harness W/H1 is configured by the extra-fine wires w1 and the fine wires w2 according to the second embodiment. The wiring harness W/H2 is configured by only fine wires w2 having a thin insulating layer, and the wiring harness W/H3 is configured by only general cables made of a thin member or a thick member which is not made of hard resin.

The cross-sectional area of a conductor of the fine wire w2 is set to 0.35 mm², and the thickness of an insulating layer covering the conductor is set to 0.2 mm so that each of the fine wires w2 is thinned.

All the wiring harnesses W/H1 to W/H3 are set to have one hundred and nine cables.

As shown in FIG. 7, both ends of the wiring harness bent in a ‘U’ shape are pressed toward each other by pressing parts 31 of a testing machine 30. In this case, when a distance D between central points O1 and O2 of both ends of the wiring harness becomes 80 mm, stress W generated in the wiring harness by the testing machine 30 is measured, thereby measuring rigidity of the wiring harness.

Assuming that the rigidity ratio of the wiring harness W/H2 is 100 on the basis of a rigidity value of the wiring harness W/H2 which is configured by the fine wires w2, the rigidity ratio of the wiring harness W/H3 which is configured by general cables is 85.

While changing the ratio of the extra-fine wires w1 to the fine wires w2, the rigidity of the wiring harness W/H1, which is configured by the extra-fine wires w1 and the fine wires w2, is measured.

Specifically, the fine wires w2 of the wiring harness W/H2 are replaced with the extra-fine wires w1 so that the percentage of the extra-fine wires w1 is large. The extra-fine wires w1 are complemented to the wiring harness W/H1 as many as the number of fine wires w2 extracted from the wiring harness W/H1 so that the total number of the extra-fine wires w1 and the fine wires w2 is constantly maintained as one hundred and nine.

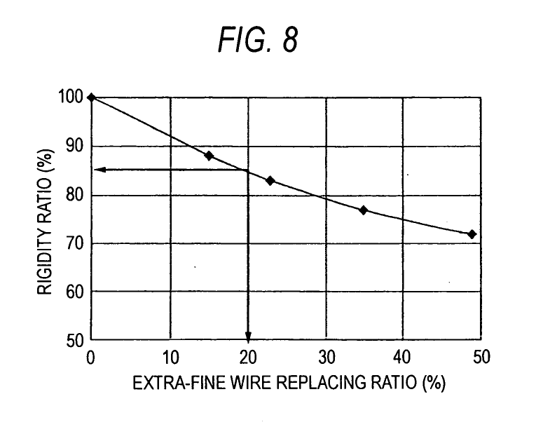

The rigidity value of the wiring harness W/H1 is measured by the same method as that used for measuring the rigidity of the wiring harnesses W/H2 and W/H3, and the rigidity ratios of the wiring harnesses W/H2 to a rigidity ratio of 100 are respectively calculated from the rigidity values of the wiring harness W/H1. The results of the computation are shown as a line graph in FIG. 8.

A horizontal axis of the line graph indicates the percentage of the extra-fine wires w1 in the wiring harness W/H1, and a vertical axis thereof indicates a rigidity ratio.

As understood from the results of the test, when the extra-fine wires w1 account for about 20% of the cables of the wiring harness W/H1, the rigidity ratio of the wiring harness W/H1 becomes 85, which is equal to that of the wiring harness W/H3. That is, if 20% of cables forming the wiring harness W/H are replaced with the extra-fine wires w1, it is possible to obtain substantially the same flexibility as the wiring harness W/H3 has.

In addition, as the percentage of the extra-fine wires w1 increases, it is confirmed that the rigidity of the wiring harness W/H1 is lowered and considerable flexibility is obtained.

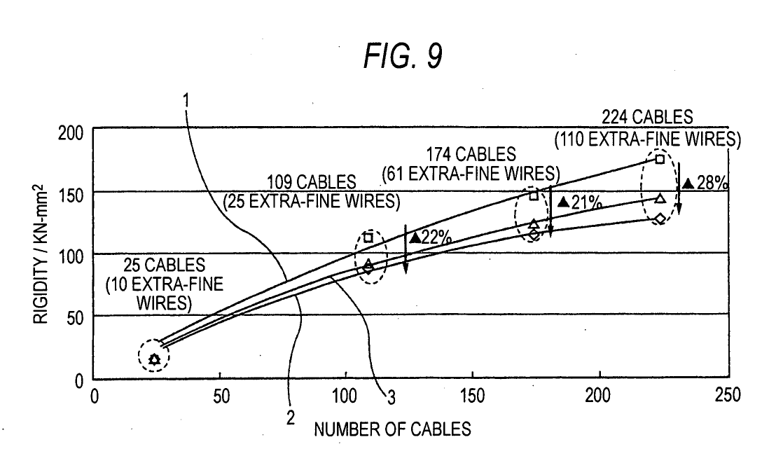

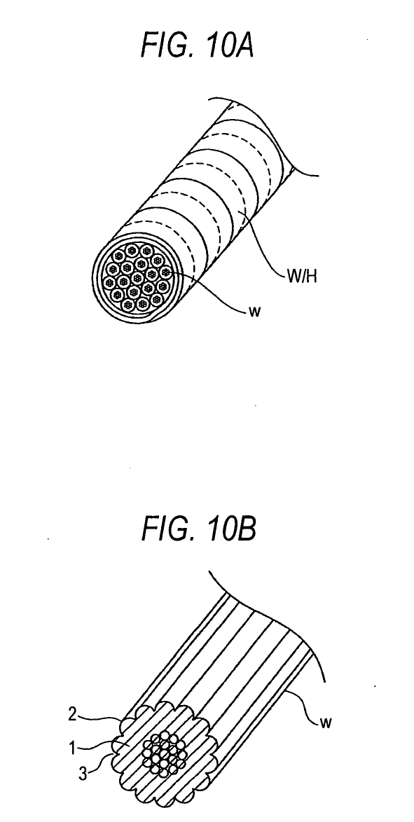

A line graph shown in FIG. 9 shows a relation between the number of cables forming a wiring harness and flexural rigidity of a wiring harness. A solid line 1 indicates the wiring harness W/H2 which is configured by only the fine wires w2, a solid line 2 indicates the wiring harness W/H1 in which the extra-fine wires w1 are used for predetermined wiring lines and the fine wires w2 are used for the other wiring lines, and a solid line 3 indicates the wiring harness W/H3. A method of measuring rigidity is the same as described above.

For example, in the wiring harness in which one hundred and nine cables are aggregated, the wiring harness W/H1 indicated by the solid line 2, which includes twenty-five extra-fine wires w1 corresponding to about 23% of the cables, has a rigidity reduced by 22% compared to the wiring harness W/H2 indicated by the solid line 1 which is configured by only the fine wires w2, and has substantially the same rigidity value as the wiring harness W/H3 indicated by the solid line 1.

Furthermore, in the wiring harness in which one hundred and seventy-four cables are aggregated, the wiring harness W/H1 indicated by the solid line 2, which includes sixty-one extra-fine wires w1 corresponding to about 35% of the cables, has a rigidity reduced by 21% compared to the wiring harness W/H2 indicated by the solid line 1 which is configured by only the fine wires w2, and has substantially the same rigidity value as the wiring harness W/H2 indicated the solid line 1.

In addition, in the wiring harness in which two hundred and twenty-four cables are aggregated, the wiring harness W/H1 indicated by the solid line 2, which includes one hundred and ten extra-fine wires w1 corresponding to about 49% of the cable, has a rigidity reduced by 28% compared to the wiring harness W/H2 indicated by the solid line 1 which is configured by only the fine wires w2, and has substantially the same rigidity value as the wiring harness W/H2 indicated by the solid line 1.

In this way, even when the number of cables forming the wiring harness is variously changed, the extra-fine wires make it possible to improve the flexibility of the wiring harness and to easily perform a wiring work.

Accordingly, the wiring harness according to the invention has the following advantages. That is, since it is possible to reduce the outer diameter of the wiring harness by combining the extra-fine wires with the thin fine wires, a wiring space can be reduced in a vehicle. Furthermore, since the wiring harness according to the invention has flexibility, wiring workability does not deteriorate.

What is claimed is:

1. A wiring harness for a vehicle, comprising:
a first wire having a conductor formed by aggregating at least one high-tensile wire material and a plurality of conductive element wires;
a second wire having a compressed conductor formed by compressing and aggregating a plurality of element wires; and
a third wire having a conductor formed by aggregating a plurality of element wires, wherein the wiring harness is formed by aggregating a cable including the first wire, the second wire, and the third wire,
wherein a cross sectional area of the conductor of the first wire is smaller than a cross sectional area of the compressed conductor of the second wire, and
wherein the cross sectional area of the compressed conductor of the second wire is smaller than a cross sectional area of the conductor of the third wire.

2. The wiring harness for a vehicle according to claim 1, wherein the high-tensile wire material of the first wire is configured by a conductive core wire,
wherein each conductive element wire of the first wire has a smaller diameter than the high-tensile wire material of the first wire, and
wherein the conductor of the third wire is configured by a plurality of element wires which are twisted.

3. The wiring harness for a vehicle according to claim 1, wherein each conductor of the cable is covered with an insulating layer made of an insulating resin, and
the cross-sectional area of the conductor of the first wire is set within a range of 0.05 to 0.3 mm², and
the cross-sectional area of the conductor of the second wire is set to be larger than 0.3 mm² and equal to or smaller than 1.5 mm².

4. The wiring harness for a vehicle according to claim 1, wherein each conductor of the first wire has a twisted-wire structure and a substantially circular cross-section formed by a core configured by the high-tensile wire material and a circumferential element wire configured by seven to nine conductive element wires which are closely arranged around the core so as to surround an outer circumferential surface of the core.

5. The wiring harness for a vehicle according to claim 4, wherein the core is configured by one high-tensile wire material.

6. The wiring harness for a vehicle according to claim 4, wherein the core is configured by two to four high-tensile wire materials.

7. The wiring harness for a vehicle according to claim 1, wherein the high-tensile wire material of the first wire is made of stainless steel,
wherein the conductive element wires of the first wire are made of copper or a copper alloy, and
wherein the element wires of the second wire have the same diameter, and
wherein the element wires of the second wire are made of copper or a copper alloy.

8. The wiring harness for a vehicle according to claim 3, wherein the insulating layer covering the compressed conductor of the second wire is made of olefin-based resin, and
wherein a thickness of the insulating layer of the second wire is substantially equal to a thickness of the insulating layer of the first wire.

9. The wiring harness for a vehicle according to claim 1, wherein 20% or more of the cable is the first wire.

10. The wiring harness for a vehicle according to claim 1, wherein the first wire is used as a signal wire.

11. The wiring harness for a vehicle according to claim 1, wherein the wiring harness for a vehicle is configured by an instrument panel harness in which the first wire accounts for 20 to 50% of the cable.

12. A wiring harness for a vehicle, comprising:
a first wire having a conductor formed by aggregating at least one high-tensile wire material and a plurality of conductive element wires; and
a second wire having a compressed conductor formed by compressing and aggregating a plurality of element wires, wherein the wiring harness is formed by aggregating a cable including the first wire, the second wire, and
wherein a cross sectional area of the conductor of the first wire is smaller than a cross sectional area of the compressed conductor of the second wire.

13. The wiring harness for a vehicle according to claim 12, wherein the high-tensile wire material of the first wire is configured by a conductive core wire, and
wherein each conductive element wire of the first wire has a smaller diameter than the high-tensile wire material of the first wire.

14. The wiring harness for a vehicle according to claim 12, wherein each conductor of the cable is covered with an insulating layer made of an insulating resin, and
the cross-sectional area of the conductor of the first wire is set within the range of 0.05 to 0.3 mm², and
the cross-sectional area of the conductor of the second wire is set to be larger than 0.3 mm² and equal to or smaller than 1.5 mm².

15. The wiring harness for a vehicle according to claim 12, wherein each conductor of the first wire has a twisted-wire structure and a substantially circular cross-section formed by a core configured by the high-tensile wire material and a circumferential element wire configured by seven to nine conductive element wires which are closely arranged around the core so as to surround an outer circumferential surface of the core.

16. The wiring harness for a vehicle according to claim 15, wherein the core is configured by one high-tensile wire material.

17. The wiring harness for a vehicle according to claim 15, wherein the core is configured by two to four high-tensile wire materials.

18. The wiring harness for a vehicle according to claim 12, wherein the high-tensile wire material of the first wire is made of stainless steel,
wherein the conductive element wires of the first wire are made of copper or a copper alloy, and
wherein the element wires of the second wire have the same diameter, and
wherein the element wires of the second wire are made of copper or a copper alloy.

19. The wiring harness for a vehicle according to claim 14, wherein the insulating layer covering the compressed conductor of the second wire is made of olefin-based resin, and
wherein a thickness of the insulating layer of the second wire is substantially equal to a thickness of the insulating layer of the first wire.

20. The wiring harness for a vehicle according to claim 12, wherein 20% or more of the cable is the first wire.

21. The wiring harness for a vehicle according to claim 12, wherein the first wire is used as a signal wire.

22. The wiring harness for a vehicle according to claim 12, wherein the wiring harness for a vehicle is configured by an instrument panel harness in which the first wire accounts for 20 to 50% of the cable.

23. The wiring harness for a vehicle according to claim 1, wherein the high-tensile wire material of the first wire is configured by a conductive core wire,
wherein each conductive element wire of the first wire has a larger diameter than the high-tensile wire material of the first wire, and
wherein the conductor of the third wire is configured by a plurality of element wires which are twisted.

24. The wiring harness for a vehicle according to claim 12, wherein the high-tensile wire material of the first wire is configured by a conductive core wire, and
wherein each conductive element wire of the first wire has a larger diameter than the high-tensile wire material of the first wire.
